(19) United States
(12) Patent Application Publication
(10) Pub. No.: US 2005/0104791 A1
(43) Pub. Date: May 19, 2005

(54) Two-layer wide-band meander-line polarizer

(76) Inventors: Liang Q Sun, Vienna, VA (US); Amir I Zaghoul, Bethesda, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/474,817

(22) PCT Filed: Apr. 15, 2002
(86) PCT No.: PCT/US02/08264

Related U.S. Application Data
(62) Division of application No. 60/283,917, filed on Apr. 13, 2001.

(51) Int. Cl. H01Q 19/00

(52) U.S. Cl. 343/756; 343/909

(57) ABSTRACT

A two-layer polarizer (6, 7) comprising a first substrate (10) having formed on a major surface thereof a first conductive meander line array (2) and a second substrate (12) having formed on a major surface thereof a second conductive meander line array (3). The first and second substrates are disposed as adjacent layers and are separated by a dielectric space (8). At least a portion of the first meander line array and a portion of said second meander line array are overlapping.

This application claims the benefit of U.S. Provisional Application No. 60/283,917, filed Apr. 13, 2001, under 35 U.S.C. § 119(e).

### BACKGROUND OF THE INVENTION

1. Field of the Invention

The present invention disclosure relates to a meander-line polarizer, particularly a polarizer having only two printed layers and operative to provide wide-band performance with a low axial ratio. The polarizer is especially useable in aperture-type antennas, particularly antennas operative to convert electromagnetic field polarization from linear to circular and from circular to linear.

2. Background of the Invention

In the related art, two orthogonal senses of linear polarization in a multilayer printed circuit structure can be produced, as well as a single circular polarization using a multilayer printed circuit structure having a meander line conductor. Previous designs of meander line polarizers used 3 to 4 layers of printed circuits to achieve the required axial ratio for the circular polarization across the band. The printed layers are separated by supporting dielectric substrate layers that are quarter-wavelength-thick. Such meander-line polarizers are expensive to manufacture and are undesirably thick. However, the related art does not disclose or suggest use of a two-layer meander line polarizer, particularly one with low axial ratio over a wide bandwidth. More specifically, the use of only two meander line layers to convert a linear polarization into a circular polarization for a single or dual senses of circular polarization has not been demonstrated as achievable in the related art. Thus, the aforementioned related art structure has at least the disadvantage of requiring extra layers in the printed circuit polarizer, which results in an increased cost, if production of an output having a single sense or two orthogonal senses is desired. Even more specifically, the prior art does not disclose an antenna in combination with a two layer meander line polarizer.

### SUMMARY OF THE INVENTION

It is an object of the present invention to overcome at least the aforementioned problems and disadvantages of the related art system.

It is another object of the present invention to minimize a number of layers present in a multilayer structure of a polarizer, thus minimizing cost and size of the polarizer.

Accordingly, a first feature of the invention involves a two-layer polarizer comprising a first substrate having formed on a major surface thereof a first conductive meander line array and a second substrate having formed on a major surface thereof a second conductive meander line array. The first and second substrates are stacked with their major surfaces in parallel as adjacent layers that are separated by a dielectric space. The separation of the two layers is less than quarter wavelength.

A second feature of the invention involves a combination of an antenna having at least one aperture, and a two layer polarizer disposed over the at least one aperture. The two-layer polarizer includes a first substrate having formed on a major surface thereof a first conductive meander line array; and a second substrate having formed on a major surface thereof a second conductive meander line array. The first and second substrates are disposed with their major surfaces in parallel as adjacent layers that are separated by a dielectric space. The separation of the two layers is less than quarter wavelength.

### BRIEF DESCRIPTION OF THE DRAWINGS

The accompanying drawings, which are included to provide a further understanding of illustrative, nonlimiting embodiments of the present invention and are incorporated in and constitute a part of this specification, illustrate embodiments of the invention and together with the description serve to explain the principles of the present invention.

FIG. 1 illustrates a configuration of the meander line polarizer layers according to the exemplary embodiment of the present invention.

FIG. 2 illustrates a detailed configuration of the dimensional relationship of the two meander line polarizer implemented in accordance with the present invention.

FIG. 3 illustrates a graphical representation of a measured axial ratio of the meander line polarizer over 500 MHz bandwidth according to the present invention.

FIG. 4 illustrates a graphical representation of a measured axial ratio of the meander line polarizer over 2 GHz bandwidth according to the present invention.

FIG. 5 illustrates an antenna in combination with a two-layer meander line polarizer disposed across the antenna aperture, according to an exemplary embodiment of the invention.

### DETAILED DESCRIPTION OF ILLUSTRATIVE EMBODIMENTS OF THE INVENTION

Reference will now be made in detail to an illustrative, non-limiting embodiment of the present invention, examples of which are illustrated in the accompanying drawings. In the present invention, the terms are meant to have the definition provided in the specification, and are otherwise not limited by the specification.

The present invention includes a first meander line polarization layer having a first conductive meander line array disposed on a major surface of a first substrate and a second meander line polarization layer having a second conductive meander line array disposed on a major surface of a second substrate. The two substrates are separated by a distance that is less than one quarter wavelength. In the illustrated example, the distance is 0.15 of a wavelength. The meander line polarizer layers introduce phase shifts and signal decomposition, which leads to decomposing the signals into two sets of orthogonal linear polarizations at phase quadratures to produce circular polarizations. The arrangement of the above-disclosed layers is described subsequently in greater detail with respect to the drawings.

As a result, low axial ratios (e.g., approximately 1 dB to 2 dB) can be obtained over antenna beam width and over a wide frequency band (e.g., greater than about 20%). Also, the minimization of the number of printed circuit layers for a transmission device, by having only two meander line polarizer layers, results in the reduction of production cost of the transmission device, e.g., an antenna. The printed circuit two-layer meander line polarizer converts signals with a single or dual linear polarizations into a single or dual circular polarizations. The design of the array and the two-layer polarizer can be scaled to different frequency bands.

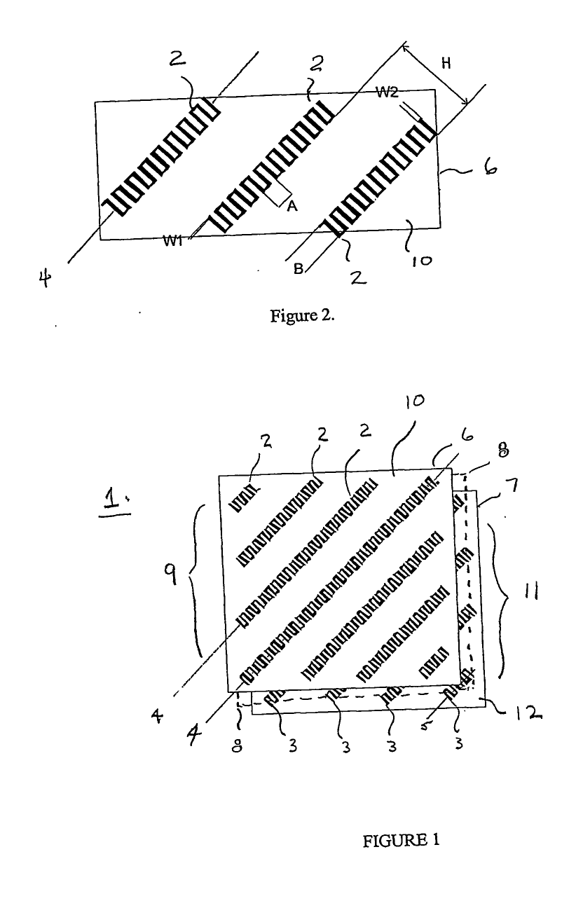

FIG. 1 shows a front view of the meander line polarizer 1 having two overlapping meander-line layers 6, 7 according to the preferred embodiment of the present invention. Each layer 6, 7 includes a respective meander line conductive strip array 9, 11. Each array has a plurality of parallel conductive strips 2, 3, respectively, and each strip is formed with a periodic and substantially square wave pattern that follows a longitudinal axis 4, 5. The meander line strip arrays 9, 11 are distributed homogeneously on a major surface of respective thin dielectric substrates 10, 12, which are made of Mylar in an exemplary embodiment. The two meander line layers 6, 7 are separated by a dielectric 8, as shown in FIG. 1. FIG. 1 further illustrates that the meander line conductive lines 2, 3 on a respective one of the meander line strip arrays 9, 11 on each of the respective meander line layers 6, 7 are printed at a 45° angle with respect to the polarization direction of a linearly polarized wave.

In operation, the two-layer meander-line polarizer 1 is used to transfer the linear polarization of propagation waves into a circular polarization. The structure of each meander-line strip array 9, 11 is designed to be predominantly inductive to one linear polarization and predominantly capacitive to the orthogonal linear polarization. Accurate spacing between two meander-line layers or sheets 6, 7 can be achieved by using low loss polyfoam as the dielectric 8 at a desired thickness. The structure of the polarizer can convert linear to circular polarization according to the following principle. The incident linearly polarized wave can be resolved into two equal linearly polarized components at ±45° relative to the incident wave. The meander lines 2, 3 on each of the respective polarizer layers are oriented at 45° relative to the incident wave. The two orthogonal components are in-phase when incident on the polarizer. On passing through the polarizer, one component goes through an inductive phase change, while the orthogonal component goes through a capacitive phase change. If a phase shift of 90° is achieved by the two wave components when they pass through the polarizer, a circularly polarized wave is generated.

The parameters that define the geometry of the periodic square wave-shaped meander-line array 9, 11 for each of the meander line layers 6, 7 are illustrated in FIG. 2. The width of the conductive material in the meander-line array W1 is a width of the conductor in the longitudinal direction (i.e., in the direction 4, 5) of the metalized line on the plane of the layers 6, 7, while the width W2 is the dimension of the conductor in a direction orthogonal to the longitudinal direction. The height of the meander-line B, which is the spacing between the apicies of the periodic square wave, is measured in the plane of the meander line layer 6, 7, while the period of the meander line is identified as A. The width parameters W1, W2 and the height B determine the operating frequency and the bandwidth of the polarizer. The distance H between each meander-line 2, 3 in each respective array 6, 7 determines the phase shift of each layer. For circuit matching purposes, layer 6 and layer 7 have different parameter values. While a square wave pattern is preferred, modifications to such periodic pattern may be utilized, as would be known to one skilled in the art.

TABLE I
Dimensions of each layers of the polarizer (inches)

| Layer # | A | B | H | W1 | W2 | Spacing |
|---|---|---|---|---|---|---|
| 6 | 0.166 | 0.110 | 0.254 | 0.013 | 0.018 | 0.094 |
| 7 | 0.240 | 0.180 | 0.254 | 0.030 | 0.040 | |

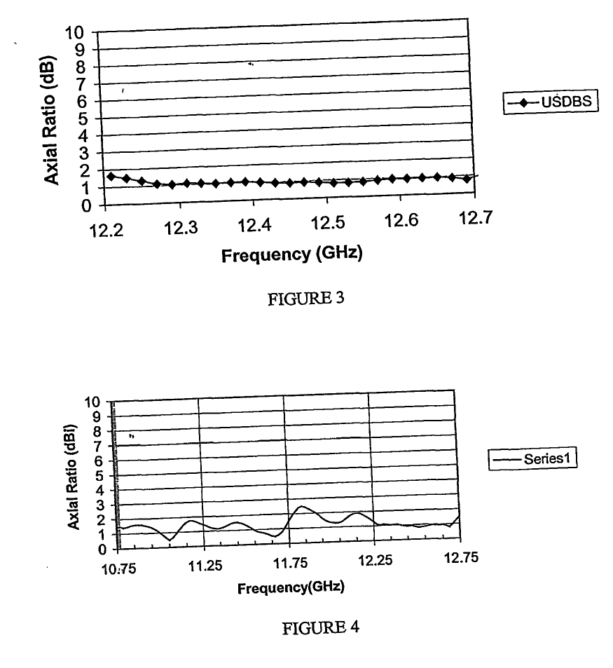

Table I lists the parameter values of an exemplary embodiment of the two-layer meander-line polarizer 1 which operates at the frequency band from 10.75 to 12.75 GHz. The spacing between the meander-line layers is about 0.094 inches, which typically is the thickness of the dielectric support layer 8, and does not include the thickness of the Mylar substrate that comprises the layers 10, 12. This spacing is substantially less than a quarter wavelength and is critical to achieving the right phase relationship that produces the circular polarizations. The measurement results of the axial ratio over the 500 MHz bandwidth defined over a range of 12.2 Ghz to 12.7 Ghz are shown in FIG. 3 and substantially demonstrate maximum value of around 1 dB. The measured value of the axial ratio for 2 GHz bandwidth between 10.75 GHz and 12.75 GHz is about 2 dB as shown in FIG. 4.

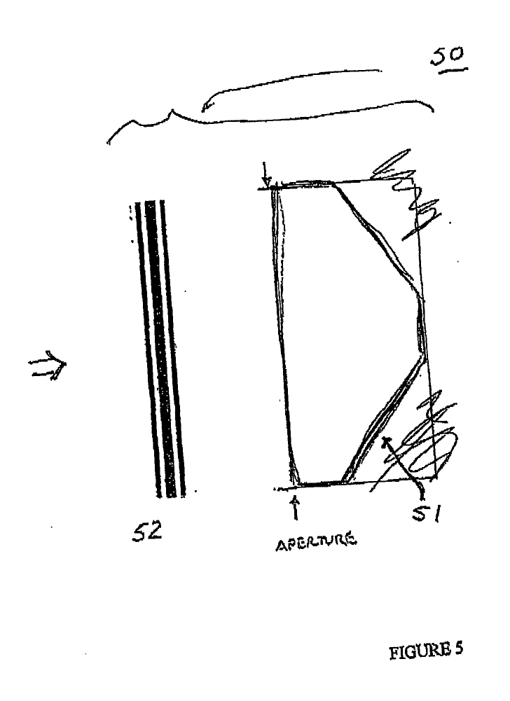

FIG. 5 illustrates a schematic of a combination 50 of an antenna 51 and a two layer polarizer 52, in accordance with the present invention. The antenna may be of any type, including a flat plate antenna or a horn antenna with a feed. The polarizer would be disposed at the aperture of the antenna and would provide the conversion between linear and circular polarization, as disclosed herein.

A significant result of the present two-layer meander-line polarizer is that the polarizer can be used with a wide variety of aperture-type antennas converting electromagnetic field polarization from linear to circular polarization, or conversely from circular to linear polarization. Also, low axial ratio (1 or 2 dB) can be obtained over antenna beamwidth and over a wide frequency band (over 20%). Indeed, the achievement of a high frequency band is a dramatic improvement over the bandwidth that previously had been limited to 16% or 17%.

It will be apparent to those skilled in the art that various modifications and variations can be made to the described illustrative embodiments of the present invention without departing from the spirit or scope of the invention. Thus, it is intended that the present invention cover all modifications and variations of this invention consistent with the scope of the appended claims and their equivalents.

1. A two-layer polarizer comprising:
a first substrate having formed on a major surface thereof a first conductive meander line array;
a second substrate having formed on a major surface thereof a second conductive meander line array,
said first and second substrates being disposed as adjacent layers and separated by a dielectric space, at least a portion of said first meander line array and a portion of said second meander line array overlapping.

2. A two-layer polarizer as claimed in claim 1, wherein said dielectric space is less than ¼ λ, where λ is the wavelength of an incoming wave.

3. A two-layer polarizer as claimed in claim 2, wherein the dielectric space is approximately 0.15 λ.

4. A two-layer polarizer as claimed in claim 1, wherein said dielectric space comprises an insulating material.

5. A two-layer polarizer as claimed in claim 1, wherein said first meander line array and said second meander line array comprises a plurality of conductive strips, each having a square wave shape.

6. A two-layer polarizer as claimed in claim 5, wherein said square wave shape comprises a period A, a height B, a horizontal width W1 and a vertical width W2.

7. A two-layer polarizer as claimed in claim 6, wherein the operating frequency and the bandwidth of the polarizer are determined by the values of B, W1 and W2.

8. A two-layer polarizer as claimed in claim 1, wherein said meander line is extended at approximately 45° with respect to a polarization direction of a linearly polarized wave.

9. A two-layer polarizer as claimed in claim 9, wherein said wherein said substrate comprises Mylar.

10. A two-layer polarizer as claimed in claim 9 wherein said dielectric space is filled with low loss polyfoam.

11. A two-layer polarizer as claimed in claim 1, wherein said polarizer exhibits an axial ratio of 2 db at 2 Ghz.

12. A two-layer polarizer as claimed in claim 1, wherein said polarizer exhibits an axial ratio of approximately 1 dB at a bandwidth of approximately 500 Mhz.

13. A two-layer polarizer as claimed in claim 7, wherein said parameters are scaled to different frequencies

14. A two-layer polarizer as claimed in claim 1, wherein said axial ratio of 2 dB is for a signal at approximately 11-13 Ghz.

15. In combination, an antenna having at least one aperture, and
a two-layer polarizer disposed over said at least one aperture and comprising:
a first substrate having formed on a major surface thereof a first conductive meander line array;
a second substrate having formed on a major surface thereof a second conductive meander line array,
said first and second substrates being disposed as adjacent layers and separated by a dielectric space, at least a portion of said first meander line array and a portion of said second meander line array overlapping.

16. A combination as claimed in claim 15 in which said two-layer polarizer dielectric space is less than ¼ λ, where λ is the wavelength of an incoming wave.

17. A combination as claimed in claim 16, wherein the dielectric space is approximately 0.15 λ.

18. In combination, an antenna having at least one aperture, and
a two-layer polarizer means disposed over said at least one aperture for transferring a linear polarization of propagation waves into a circular polarization.

19. The combination as set forth in claim 18, wherein said two layer polarizer means is operative to introduce phase shifts and signal decomposition, which leads to two orthogonal linear polarizations at phase quadrature to produce circular polarization.

20. The combination as set forth in claim 18, wherein said combination provides an axial ratio less than or equal to 2 dB.
